(19) United States
(12) Patent Application Publication
(10) Pub. No.: US 2026/0026433 A1
(43) Pub. Date: Jan. 29, 2026

(54) CUTTING ASSEMBLY AND ROBOTIC LAWNMOWER

(71) Applicant: HUSQVARNA AB, Huskvarna (SE)

(72) Inventor: Ethan OGBURN, Huskvarna (SE)

(21) Appl. No.: 19/277,603

(22) Filed: Jul. 23, 2025

(30) Foreign Application Priority Data
Jul. 23, 2024 (SE) 2450819-4

(51) Int. Cl. A01D 34/74; A01D 34/64; A01D 34/73; A01D 34/78; A01D 101/00

(52) U.S. Cl. CPC A01D 34/74; A01D 34/64; A01D 34/733; A01D 34/78; A01D 2101/00

(57) ABSTRACT

A cutting assembly may be configured to be mounted to a robotic lawnmower to cut vegetation. The cutting assembly includes a mounting unit configured to be mounted to a lawnmower body of the robotic lawnmower, a cutting arrangement including a cutting unit, a link arm arrangement connecting the cutting arrangement to the mounting unit, and a cutting height adjustment mechanism. The link arm arrangement includes a number of link arms each pivotally attached to the mounting unit and to the cutting arrangement around pivot axes. The cutting height adjustment mechanism includes an actuator arm slidably received in an aperture of the cutting arrangement and a linear actuator configured to move the actuator arm relative to the mounting unit.

### TECHNICAL FIELD

The present disclosure relates to a cutting assembly configured to be mounted to a robotic lawnmower to cut vegetation. The present disclosure further relates to a robotic lawnmower comprising a cutting assembly.

### BACKGROUND

A robotic lawnmower is a lawnmower capable of cutting grass in areas in an autonomous manner, i.e., in a manner not requiring a direct human intervention. Some robotic lawnmowers require a user to set up a border wire around a lawn that defines the area to be mowed. Such robotic lawnmowers use a sensor to locate the wire and thereby determine the boundary of the area to be trimmed. In addition to the wire, robotic lawnmowers may also comprise other types of positioning units and sensors, for example, sensors for detecting an event, such as a collision with an object within the area. The robotic lawnmower may move in a systematic and/or random pattern to ensure that the area is completely cut. A robotic lawnmower usually comprises one or more batteries and one or more electrically driven cutting units being powered by the one or more batteries. In some cases, the robotic lawnmower uses the wire to locate a recharging dock used to recharge the one or more batteries. Generally, robotic lawnmowers operate unattended within the area in which they operate. Examples of such areas include lawns, gardens, parks, sports fields, golf courses, and similar environments.

Many robotic lawnmowers comprise a cutting height adjustment mechanism controllable to adjust the cutting height by adjusting the relative position of the one or more cutting units relative to a lawnmower body of the robotic lawnmower. In many robotic lawnmowers, the maximum travel range provided by this cutting height adjustment mechanism is limited due to constructional restraints, usually to about 50 mm.

However, a larger maximum travel range could provide many advantages, such as decreasing the number of overall sellable products, eliminating the need for separate high-cut and low-cut models, and to provide customers with the flexibility to cut different parts of their lawn to varying heights. For instance, a customer with tall fescue in the backyard and Bermuda grass in the front yard may want to cut them to heights of 100 mm and 40 mm, respectively. This capability is impossible with many robotic lawnmowers, necessitating that a customer either compromise on their ideal lawn cut height or purchase two separate lawnmowers.

The development of a cutting height adjustment mechanism capable of achieving large maximum travel range must address several challenges and design difficulties. One problem is that a design capable of achieving a large maximum travel range risks impairing the structural integrity of the cutting assembly. Structural integrity of a cutting assembly is important for many reasons, such as preventing damage of the cutting assembly, or other parts of the robotic lawnmower, if the cutting unit is hitting an object during operation.

Moreover, it is important to eliminate unnecessary extra parts, which not only complicate the design but also increase the potential points of failure. Furthermore, it is an advantage if the design can facilitate ease of assembly in a factory, streamlining production processes and reducing manufacturing costs. Additionally, there is a need to decrease the size of the robotic lawnmowers, and associated arrangements and assemblies, to enhance manoeuvrability and storage convenience without compromising performance.

### SUMMARY

It is an object of the present invention to overcome, or at least alleviate, at least some of the above-mentioned problems and drawbacks. The object is achieved by the subject-matter of the appended independent claim(s).

According to a first aspect of the present disclosure, the object is achieved by a cutting assembly configured to be mounted to a robotic lawnmower to cut vegetation. The cutting assembly comprises a mounting unit configured to be mounted to a lawnmower body of the robotic lawnmower, a cutting arrangement comprising a cutting unit, a link arm arrangement connecting the cutting arrangement to the mounting unit, and a cutting height adjustment mechanism. The link arm arrangement comprises a number of link arms each pivotally attached to the mounting unit and to the cutting arrangement around pivot axes. The cutting height adjustment mechanism comprises an actuator arm slidably received in an aperture of the cutting arrangement and a linear actuator configured to move the actuator arm relative to the mounting unit.

Due to the number of link arms and the actuator arm slidably received in the aperture of the cutting arrangement, conditions are provided for obtaining a large travel distance of the cutting arrangement relative to the mounting unit, and thereby a large cutting height adjustment range, without impairing the structural rigidity of the cutting assembly.

This is because the number of link arms can take up and transfer forces between cutting unit and the mounting unit in an efficient manner. Furthermore, due to the number of link arms and the actuator arm slidably received in the aperture of the cutting arrangement, the cutting arrangement has freedom to move relative to the mounting unit in an overstress situation, such as a collision between the cutting unit and an external item like a rock or root. This flexibility helps protect the linear actuator and other components of the cutting assembly from damage during such incidents.

Furthermore, due to the features of the cutting assembly, conditions are provided for a compact cutting assembly facilitating ease of assembly in a factory, streamlining production processes, and reducing manufacturing costs, without compromising performance.

Accordingly, a cutting assembly is provided overcoming, or at least alleviating, at least some of the above-mentioned problems and drawbacks. As a result, the above-mentioned object is achieved.

Optionally, the linear actuator is configured to move the actuator arm in directions perpendicular to each of the pivot axes. Thereby, improved conditions are provided for a compact cutting assembly in which the cutting height can be adjusted within a large cutting height adjustment range without compromising the structural integrity of the cutting assembly. Moreover, damage to the linear actuator can be prevented, for example upon a collision between the cutting unit and an external item.

Optionally, the linear actuator is configured to move the actuator arm in directions being perpendicular to directions in which the actuator arm is slidably received in the aperture. Thereby, improved conditions are provided for a compact cutting assembly capable of obtaining a large cutting height adjustment range without compromising the structural integrity of the cutting assembly. Moreover, damage to the linear actuator can be prevented, for example upon a collision between the cutting unit and an external item.

Optionally, the linear actuator is arranged at least partially between the link arms of the link arm arrangement. Thereby, conditions are provided for a compact and robust cutting assembly.

Optionally, the linear actuator comprises a screw rotatably arranged relative to the mounting unit around a rotation axis, a motor controllable to rotate the screw around the rotation axis, and a follower portion, and wherein the follower portion is fix relative to the actuator arm and comprises threads arranged in engaging contact with treads of the screw. Thereby, improved conditions are provided for a compact cutting assembly facilitating ease of assembly in a factory, streamlining production processes, and reducing manufacturing costs, without compromising performance. Moreover, damage to the linear actuator, including the motor thereof, can be prevented, for example upon a collision between the cutting unit and an external item.

Optionally, the cutting unit comprises a cutting disc and a number of cutting members each pivotally arranged at a periphery of the cutting disc. Thereby, conditions are provided for a cutting assembly having a high cutting efficiency and low energy consumption. Moreover, damage to the cutting unit, and to other parts of the cutting assembly, can be prevented upon a collision between the cutting unit and an external item.

Optionally, the cutting arrangement comprises a motor configured to rotate the cutting unit. Thereby, conditions are provided for a compact robotic lawnmower comprising the cutting assembly.

Optionally, the motor is an electric motor. Thereby, conditions are provided for an environmentally friendly and compact cutting assembly having a high cutting efficiency and low energy consumption.

Optionally, the cutting arrangement comprises a motor mount unit, wherein the motor is arranged inside the motor mount unit, and wherein the aperture extends through at least part of the motor mount unit. Thereby, further improved conditions are provided for a compact cutting assembly facilitating ease of assembly in a factory, streamlining production processes, and reducing manufacturing costs, while obtaining a large cutting height adjustment range, without impairing the structural rigidity or the performance of the cutting assembly.

Optionally, the aperture extends through the motor mount unit a distance greater than half the diameter of the motor mount unit as measured in directions coinciding with sliding directions of the actuator arm in the aperture. Thereby, improved conditions are provided for ensuring structural rigidity and durability of the cutting assembly while providing conditions for obtaining a large cutting height adjustment range.

Optionally, the aperture extends through the entire motor mount unit. Thereby, further improved conditions are provided for ensuring structural rigidity and durability of the cutting assembly while providing conditions for obtaining a large cutting height adjustment range.

Optionally, a geometrical centre axis of the motor mount unit extends through the actuator arm. Thereby, further improved conditions are provided for a compact cutting assembly facilitating ease of assembly in a factory, streamlining production processes, and reducing manufacturing costs, while obtaining a large cutting height adjustment range, without impairing the structural rigidity or performance of the cutting assembly.

Optionally, the motor mount unit comprises a main body and a lid, wherein the lid is removably attached to the main body, and wherein the aperture is formed between surfaces of the lid and surfaces of the main body. Thereby, a cutting assembly is provided facilitating ease of assembly in a factory, streamlining production processes, and reducing manufacturing costs. Furthermore, a cutting assembly is provided having conditions for facilitated service and repair. In addition, it can be ensured that no components of the cutting assembly become unconnected during operation.

Optionally, the lid is removably attached to the main body using a number of fastening elements. Thereby, a cutting assembly is provided capable of further facilitating ease of assembly in a factory, streamlining production processes, and reducing manufacturing costs. Furthermore, a cutting assembly is provided having improved conditions for facilitated service and repair and it can be further ensured that no components of the cutting assembly become unconnected during operation.

Optionally, the aperture is formed by a slot. Thereby, the structural integrity and compactness of the cutting assembly can be further ensured.

Optionally, the slot is u-shaped. Thereby, the structural integrity and robustness of the cutting assembly can be further ensured.

Optionally, the link arm arrangement comprises four link arms. Thereby, it can be ensured that the link arm arrangement can take up and transfer forces between cutting unit and the mounting unit in an efficient manner. Furthermore, it can be ensured that the cutting arrangement has freedom to move relative to the mounting unit in an overstress situation, such as a collision between the cutting unit and an external item which helps to protect the linear actuator and other components of the cutting assembly from damage during such incidents. Furthermore, since the link arm arrangement comprises four link arms, conditions are provided for a compact cutting assembly capable of obtaining a large cutting height adjustment range, without impairing the structural rigidity or performance of the cutting assembly.

Optionally, the link arms of the link arm arrangement are of equal length. Thereby, a cutting assembly is provided in which an orientation angle of the cutting arrangement relative to the mounting unit can be maintained upon movement of the cutting arrangement relative to the mounting unit.

Optionally, the linear actuator is controllable to move the actuator arm between two end positions, and wherein the link arm arrangement is configured such that an angle between a sliding direction of the actuator arm in the aperture and a plane comprising a first pivot axis of a link arm at the cutting arrangement and a second pivot axis of the link arm at the mounting unit is less than 15 degrees, or is less than 5 degrees, when the actuator arm is positioned at a midpoint between the two end positions. Thereby, the structural integrity of the cutting assembly can be further ensured when the actuator arm is positioned at the midpoint between the two end positions. As understood from the above described, the actuator arm is positioned at the midpoint when the cutting height adjustment mechanism is set to a mid-setting between a lowermost and uppermost cutting height setting. Such setting and adjacent settings may be most frequently used in a robotic lawnmower. Accordingly, due to these features, the structural integrity of the cutting assembly can be further ensured upon using commonly used settings of the cutting height adjustment mechanism. In addition, due to these features, further improved conditions are provided for a compact cutting assembly.

According to a second aspect of the present disclosure, the object is achieved by a robotic lawnmower comprising a cutting assembly according to the first aspect of the present disclosure. Since the robotic lawnmower comprises a cutting assembly according to the first aspect of the present disclosure, a robotic lawnmower is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the present disclosure, including its particular features and advantages, will be readily understood from the example embodiments discussed in the following detailed description and the accompanying drawings, in which:

FIG. 1 schematically illustrates a robotic lawnmower according to some embodiments,

FIG. 2 illustrates a perspective view of a cutting assembly of the robotic lawnmower illustrated in FIG. 1,

FIG. 3 illustrates a side view of the cutting assembly illustrated in FIG. 2,

FIG. 4 illustrates a cross section of the cutting assembly illustrated in FIG. 2 and FIG. 3,

FIG. 5 illustrates the cross section of the cutting assembly illustrated in FIG. 4 in which a linear actuator of a cutting height adjustment mechanism has moved a cutting arrangement of the cutting assembly to a higher cutting position than what is illustrated in FIG. 4,

FIG. 6 illustrates a sectional view of the cutting assembly depicted in FIG. 2-FIG. 5,

FIG. 7 illustrates the perspective view of the cutting assembly illustrated in FIG. 2, in which a lid of a motor mount unit of the cutting assembly has been removed,

FIG. 8a illustrates a perspective view of the lid of the motor mount unit of the cutting assembly according to the embodiments illustrated in FIG. 2-FIG. 7,

FIG. 8b illustrates a sectional view of the lid illustrated in FIG. 8a, and

FIG. 8c illustrates a side view of the lid illustrated in FIG. 8a.

### DETAILED DESCRIPTION

Aspects of the present disclosure will now be described more fully. Like reference signs refer to like elements throughout. Well-known functions or constructions will not necessarily be described in detail for brevity and/or clarity.

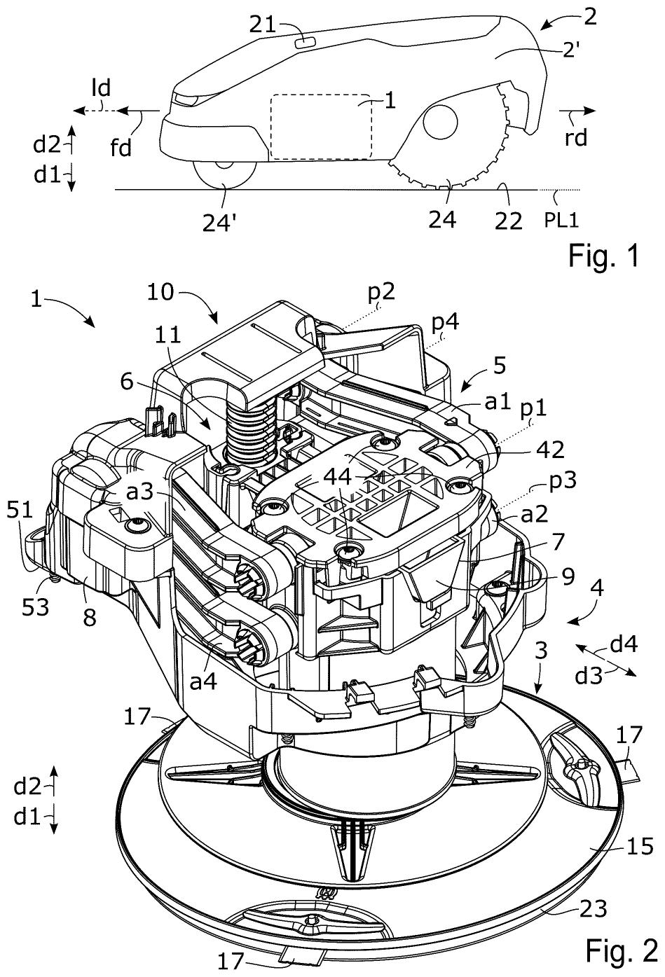

FIG. 1 schematically illustrates a robotic lawnmower 2 according to some embodiments of the present disclosure. According to the illustrated embodiments, the robotic lawnmower 2 is capable of navigating and cutting grass in an autonomous manner in an area without the intervention or the direct control of a user. The robotic lawnmower 2, as referred to herein, may also be referred to as a self-propelled robotic lawnmower.

According to the embodiments herein, the robotic lawnmower 2 is a small or mid-sized robotic lawnmower 2 configured to be used to cut grass in areas used for aesthetic and recreational purposes, such as gardens, parks, city parks, sports fields, lawns around houses, apartments, commercial buildings, offices, and the like.

The robotic lawnmower 2 comprises a lawnmower body 2′ and a number of lawnmower support members 24, 24′ each configured to abut against a ground surface 22 in a first plane PL1 during operation of the robotic lawnmower 2 to support the lawnmower body 2′. The lawnmower body 2′, as referred to herein, may also be referred to as a lawnmower chassis. Accordingly, the first plane PL1 will extend along a ground surface 22 when the robotic lawnmower 2 is positioned in an intended use position on a flat ground surface 22. In FIG. 1, the robotic lawnmower 2 is schematically illustrates in the intended use position on the ground surface 22.

According to the illustrated embodiments, the lawnmower support members 24, 24′ is wheels 24, 24′ of the robotic lawnmower 2. According to the illustrated embodiments, the robotic lawnmower 2 comprises four wheels 24, 24′, namely two drive wheels 24 and two support wheels 24′. The drive wheels 24 of the robotic lawnmower 2 may each be powered by an electrical motor of the robotic lawnmower 2 to provide motive power and/or steering of the robotic lawnmower 2. In FIG. 1, a longitudinal direction ld of the robotic lawnmower 2 is indicated. The longitudinal direction ld of the robotic lawnmower 2 is parallel to the first plane PL1 and thus also to a ground surface 22 when the robotic lawnmower 2 is positioned in the intended use position onto a flat ground surface 22. Moreover, the longitudinal direction ld of the robotic lawnmower 2 is parallel to a forward direction fd of travel of the robotic lawnmower 2 as well as a reverse direction rd of travel of the robotic lawnmower 2.

According to the illustrated embodiments, the drive wheels 24 of the robotic lawnmower 2 are non-steered wheels having a fix rolling direction in relation to the lawnmower body 2′. The respective rolling direction of the drive wheels 24 of the robotic lawnmower 2 is substantially parallel to the longitudinal direction ld of the robotic lawnmower 2. According to the illustrated embodiments, the support wheels 24′ are non-driven wheels. Moreover, according to the illustrated embodiments, the support wheels 24′ can pivot around a respective pivot axis such that the rolling direction of the respective support wheel 24′ can follow a travel direction of the robotic lawnmower 2.

As understood from the above, when the drive wheels 24 of the robotic lawnmower 2 are rotated at the same rotational speed in a forward rotational direction, and no wheel slip is occurring, the robotic lawnmower 2 will move in the forward direction fd indicated in FIG. 1. Likewise, when the drive wheels 24 of the robotic lawnmower 2 are rotated at the same rotational speed in a reverse rotational direction, and no wheel slip is occurring, the robotic lawnmower 2 will move in the reverse direction rd indicated in FIG. 1. The reverse direction rd is opposite to the forward direction fd.

According to the illustrated embodiments, the robotic lawnmower 2 may be referred to as a four-wheeled rear wheel driven robotic lawnmower 2. According to further embodiments, the robotic lawnmower 2 may be provided with another number of wheels 24, 24′, such as three wheels. Moreover, according to further embodiments, the robotic lawnmower 2 may be provided with another configuration of driven and non-driven wheels, such as a front wheel drive or an all-wheel drive.

According to the illustrated embodiments, the robotic lawnmower 2 comprises a control arrangement 21. The control arrangement 21 may be configured to control propulsion of the robotic lawnmower 2, and steer the robotic lawnmower 2, by controlling electrical motors of the robotic lawnmower 2 arranged to drive the drive wheels 24 of the robotic lawnmower 2. According to further embodiments, the control arrangement 21 may be configured to steer the robotic lawnmower 2 by controlling the angle of steered wheels of the robotic lawnmower 2. According to still further embodiments, the robotic lawnmower may be an articulated robotic lawnmower, wherein the control arrangement 21 may be configured to steer the robotic lawnmower by controlling the angle between frame portions of the articulated robotic lawnmower.

The control arrangement 21 may be configured to control propulsion of the robotic lawnmower 2, and steer the robotic lawnmower 2, so as to navigate the robotic lawnmower 2 in an area to be operated. The robotic lawnmower 2 may further comprise one or more sensors arranged to sense a magnetic field of a wire, and/or one or more positioning units, and/or one or more sensors arranged to detect an impending or ongoing collision event with an object. In addition, the robotic lawnmower 2 may comprise a communication unit connected to the control arrangement 21. The communication unit may be configured to communicate with a remote communication unit to receive instructions therefrom and/or to send information thereto. The communication may be performed wirelessly over a wireless connection such as the internet, or a wireless local area network (WLAN), or a wireless connection for exchanging data over short distances using short-wavelength, i.e. ultra-high frequency (UHF) radio waves in the industrial, scientific, and medical (ISM) band from 2.4 to 2.486 GHz.

The control arrangement 21 may be configured to control propulsion of the robotic lawnmower 2, and steer the robotic lawnmower 2, so as to navigate the robotic lawnmower 2 in a systematic and/or random pattern to ensure that an area is completely covered, using input from one or more of the above described sensors and/or units. Furthermore, the robotic lawnmower 2 may comprise one or more batteries arranged to supply electricity to components of the robotic lawnmower 2. As an example, the one or more batteries may be arranged to supply electricity to electrical motors of the robotic lawnmower 2 by an amount controlled by the control arrangement 21.

Moreover, as schematically indicated in FIG. 1, the robotic lawnmower 2 comprises a cutting assembly 1. As is further explained herein, the cutting assembly 1 is configured to cut vegetation, such as grass.

FIG. 2 illustrates a perspective view of the cutting assembly 1 of the robotic lawnmower 2 illustrated in FIG. 1. Below, simultaneous reference is made to FIG. 1 and FIG. 2, if not indicated otherwise.

The cutting assembly 1 comprises a mounting unit 8 configured to be mounted to the lawnmower body 2′ of the robotic lawnmower 2. In other words, the cutting assembly 1 is configured to be mounted to the lawnmower body 2′ of the robotic lawnmower 2 via the mounting unit 8. The mounting unit 8 comprises a number of fastening sections 51 configured to be fastened to the lawnmower body 2′ using a number of fastening elements 53, such as screws. In FIG. 1, only one fastening section 51 and one fastening element 53 have been provided with a reference sign for reasons of brevity and clarity.

As indicated in FIG. 2, the cutting assembly 1 comprises a cutting unit 3. According to the illustrated embodiments, the cutting unit 3 comprises a cutting disc 15 and a number of cutting members 17, wherein each of the number of cutting members 17 is pivotally arranged at a periphery of the cutting disc 15. According to further embodiments, the cutting unit 3 may comprise another type of cutting unit, such as a fix cutting arm, or the like.

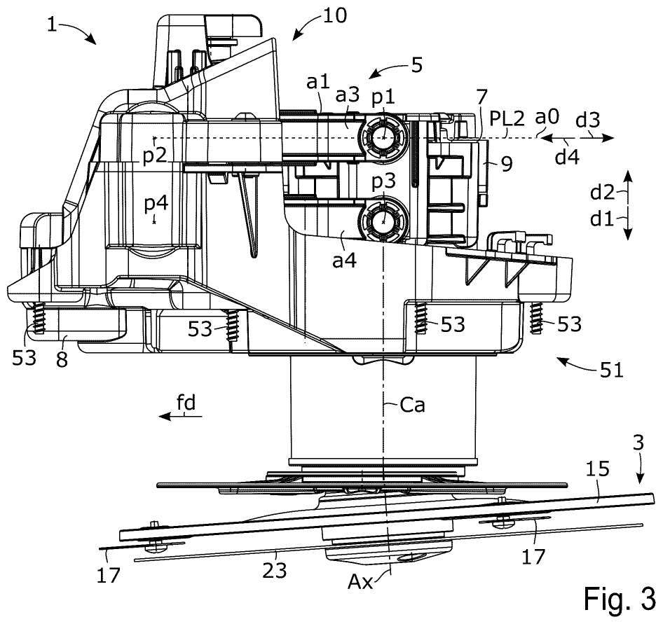

FIG. 3 illustrates a side view of the cutting assembly 1 illustrated in FIG. 2. In FIG. 3, each visible fastening element 53 of the number of fastening sections 51 of the mounting unit 8 has been provided with a reference sign. Moreover, in FIG. 3, a rotation axis Ax of the cutting unit 3 has been indicated. That is, as is further explained in the following, the cutting unit 3 is configured to be rotated by a motor of the cutting assembly 1 around the rotation axis Ax during operation.

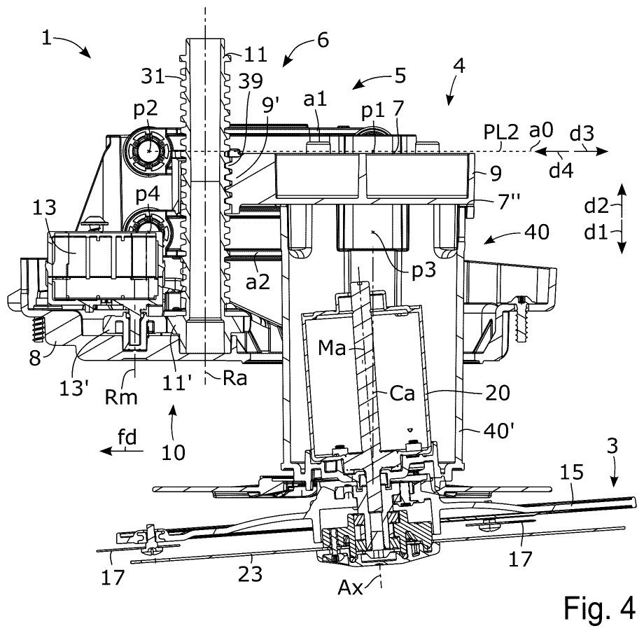

FIG. 4 illustrates a cross section of the cutting assembly 1 illustrated in FIG. 2 and FIG. 3. Below, simultaneous reference is made to FIG. 1-FIG. 4, if not indicated otherwise. In FIG. 4, the motor 20 of the cutting arrangement 4 can be seen. As mentioned, the motor 20 is configured to rotate the cutting unit 3 around the rotation axis Ax. According to the illustrated embodiments, the motor 20 is an electric motor configured to be powered using electricity from the one or more batteries of the robotic lawnmower 2.

According to the illustrated embodiments, the motor 20 comprises a rotor rigidly connected to the cutting unit 3. That is, according to the illustrated embodiments, the rotor of the motor 20 is configured to rotate with the cutting unit 3 around the rotation axis Ax. In other words, as can be seen in FIG. 4, according to the illustrated embodiments, a rotation axis Ma of the rotor coincides with the rotation axis Ax of the cutting unit 3.

However, according to further embodiments, the cutting arrangement 4 may comprise a transmission between the rotor of the motor 20 and the cutting unit 3 and the rotation axis Ma of the rotor of the motor 20 may not coincide with the rotation axis Ax of the cutting unit 3. Such a transmission may comprise one or more of gearing and a belt and pulley arrangement.

The cutting arrangement 4 comprises a motor mount unit 40, wherein the motor 20 is arranged inside the motor mount unit 40. In FIG. 3 and FIG. 4, a geometrical centre axis Ca of the motor mount unit 40 is indicated. According to the illustrated embodiments, the geometrical centre axis Ca of the motor mount unit 40 is perpendicular to the first plane PL1 indicated in FIG. 1 when the cutting assembly 1 is mounted to the robotic lawnmower 2.

As can be seen in FIG. 3 and FIG. 4, according to the illustrated embodiments, the motor 20 is arranged at an angle relative to the motor mount unit 40 such that the rotation axis Ma of the rotor of the motor 20, and thereby also the axis of rotation Ax of the cutting unit 3, is angled relative to the geometrical centre axis Ca of the motor mount unit 40. As a result, the number of cutting members 17 of the cutting unit 3 will orbit in a cutting plane being angled relative to the first plane PL1 indicated in FIG. 1.

In FIG. 3 and FIG. 4, the forward moving direction fd of the robotic lawnmower 2 is indicated. As can be seen when comparing FIG. 1, FIG. 3, and FIG. 4, the angle between the rotation axis Ax of the cutting unit 3 and the first plane PL1 is such that a leading portion of the cutting unit 3 is closer to the first plane PL1, and thus also closer to a ground surface 22 when the robotic lawnmower 2 is positioned in an intended use position on the ground surface 22, than a trailing portion of the cutting unit 3 as seen relative to the forward moving direction fd of the robotic lawnmower 1.

According to the illustrated embodiments, the angle between the cutting plane of the cutting unit 3 and the first plane PL1, and thus also the angle between the rotation axis Ax of the cutting unit 3 and the geometrical centre axis Ca of the motor mount unit 40, is approximately 4 degrees. However, according to further embodiments, one or both of these angles may be within the range of 0-10 degrees, or may be within the range of 2-7 degrees. The angle between the cutting plane of the cutting unit 3 and the first plane PL1 can enhance cutting efficiency by allowing the number of cutting members 17 to engage the grass more effectively, providing a cleaner and more even cut. Moreover, this angle can improve mulching, reduce energy consumption, and reduce wear on the number of cutting members 17.

As seen in FIG. 2-FIG. 4, the cutting assembly 1 comprises a link arm arrangement 5. The link arm arrangement 5 is connecting the cutting arrangement 4 to the mounting unit 8. The link arm arrangement 5 comprises a number of link arms a1-a4 each pivotally attached to the mounting unit 8 and to the cutting arrangement 4 around pivot axes p1-p4. That is, in more detail, according to the illustrated embodiments, the link arm arrangement 5 comprises four link arms a1-a4. According to further embodiments, the link arm arrangement 5 may comprise another number of link arms a1-a4, such as five or six. Moreover, according to the illustrated embodiments, the link arms a1-a4 of the link arm arrangement 5 are of equal length.

In some places below, the link arms a1-a4 of the link arm arrangement 5 are referred to as a first link arm a1, a second link arm a2, a third link arm a3, and a fourth link arm a4. The first link arm a1 is pivotally attached to the motor mount unit 40 of the cutting arrangement 4 around a first pivot axis p1 and is pivotally attached to the mounting unit 8 around a second pivot axis p2. Likewise, the third link arm a3 is pivotally attached to the motor mount unit 40 of the cutting arrangement 4 around the first pivot axis p1 and is pivotally attached to the mounting unit 8 around the second pivot axis p2. In other words, the first and third link arms a1, a3 will move in unison and are pivotally arranged around the same pivot axes p1, p2.

The second link arm a2 is pivotally attached to the motor mount unit 40 of the cutting arrangement 4 around a third pivot axis p3 and is pivotally attached to the mounting unit 8 around a fourth pivot axis p4. Likewise, the fourth link arm a4 is pivotally attached to the motor mount unit 40 of the cutting arrangement 4 around the third pivot axis p3 and is pivotally attached to the mounting unit 8 around the fourth pivot axis p4. In other words, the second and fourth link arms a2, a4 will move in unison and are pivotally arranged around the same pivot axes p3, p4.

According to the illustrated embodiments, the pivot axes p1-p4 of the link arms a1-a4 in the link arm arrangement 5 are parallel to each other. Moreover, according to the illustrated embodiments, each pivot axis p1-p4 of the link arms a1-a4 in the link arm arrangement 5 is parallel to the first plane PL1 when the cutting assembly 1 is mounted to the robotic lawnmower 2, and this also parallel to a ground surface 22 when the robotic lawnmower 2 is positioned in an intended use position thereon. According to further embodiments, each pivot axis p1-p4 of the link arms a1-a4 in the link arm arrangement 5 may be substantially parallel to the first plane PL1 when the cutting assembly 1 is mounted to the robotic lawnmower 2. In this context, the wording substantially parallel to, may mean that the angle between the first plane PL1 and each pivot axis p1-p4 of the link arms a1-a4 in the link arm arrangement 5 is less than 10 degrees, or is less than 5 degrees.

As indicated in FIG. 2 and FIG. 4, the cutting assembly 1 comprises a cutting height adjustment mechanism 6. The cutting height adjustment mechanism 6 comprises an actuator arm 9. The actuator arm 9 is slidably received in an aperture 7 of the cutting arrangement 4.

The cutting height adjustment mechanism 6 comprises a linear actuator 10 configured to move the actuator arm 9 relative to the mounting unit 8. In more detail, according to the illustrated embodiments, the linear actuator 10 is configured to move the actuator arm 9 in directions d1, d2 perpendicular to each of the pivot axes p1-p4.

The actuator arm 9 is slidably received in the aperture 7 in directions d3, d4 perpendicular to the directions d1, d2 in which the linear actuator 10 is configured to move the actuator arm 9. In other words, the linear actuator 10 is configured to move the actuator arm 9 in directions d1, d2 being perpendicular to directions d3, d4 in which the actuator arm 9 is slidably received in the aperture 7.

According to the illustrated embodiments, the directions d1, d2 in which the linear actuator 10 is configured to move the actuator arm 9 is perpendicular to the first plane PL1 when the cutting assembly 1 is mounted to the robotic lawnmower 2. According to further embodiments, the angle between the directions d1, d2 in which the linear actuator 10 is configured to move the actuator arm 9 and the first plane PL1 may be within the range of 70-110 degrees, or may be within the range of 80-100 degrees.

As understood from the above described, according to the illustrated embodiments, the directions d3, d4 in which the actuator arm 9 is slidably received in the aperture 7 are parallel to the first plane PL1 when the cutting assembly 1 is mounted to the robotic lawnmower 2. Like above, according to further embodiments, the angle between the directions d3, d4 in which the actuator arm 9 is slidably received in the aperture 7 and the first plane PL1 may be less than 20 degrees, or may be less than 10 degrees.

Consequently, due to these features, the linear actuator 10 of the cutting height adjustment mechanism 6 is configured to move the cutting arrangement 4 in directions d1, d2 towards and away from the first plane PL1, and thereby also towards and away from a ground surface 22 when the robotic lawnmower 2 is positioned in the intended use position thereon. In this manner, the cutting height provided by the robotic lawnmower 2 can be adjusted.

Moreover, as understood from the above described, the link arm arrangement 5 provides an arc-shaped travel path of the cutting arrangement 4 relative to the mounting unit 8 due to the constant length of the link arms a1-a4 of the link arm arrangement 5. Moreover, the actuator arm 9 will slide in the aperture 7 of the cutting arrangement 4 upon movement of the cutting arrangement 4 relative to the mounting unit 8.

The term “aperture” as used herein refers to an opening formed within the cutting arrangement 4, in which the received actuator arm 9 is at least partially enclosed and guided. According to the illustrated embodiments, the aperture 7 is formed as a slot within a structural part of the cutting arrangement 4. Moreover, the surrounding structure forming the aperture 7 encloses the actuator arm 9 in a plane that is perpendicular to the directions d3, d4 in which the actuator arm 9 is slidably received. Thereby, the actuator arm 9 is enclosed and supported by the surrounding structure forming the aperture 7 in the directions d1 and d2. This structural configuration enables the aperture 7 to guide movement of the actuator arm 9 in the directions d3, d4 while also providing structural support in the directions d1, d2.

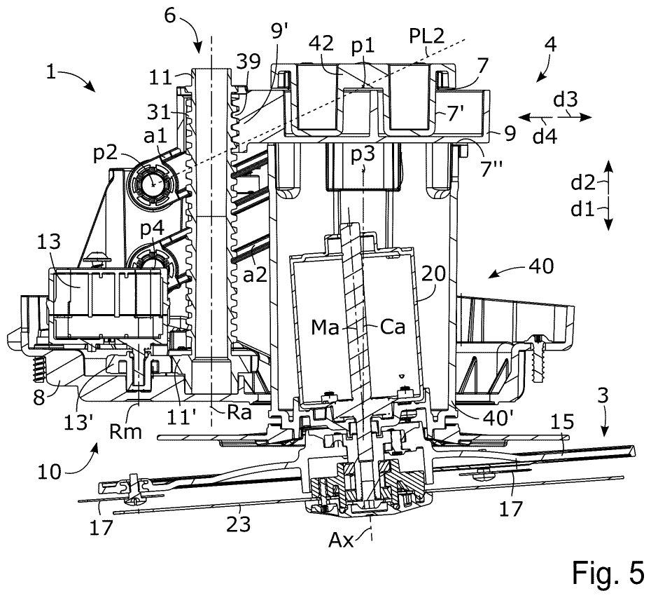

FIG. 5 illustrates the cross section of the cutting assembly 1 illustrated in FIG. 4 in which the linear actuator 10 of the cutting height adjustment mechanism 6 has moved the cutting arrangement 4 to a higher cutting position than what is illustrated in FIG. 4. Below, simultaneous reference is made to FIG. 1-FIG. 5, if not indicated otherwise.

According to embodiments herein, the linear actuator 10 is controllable to move the actuator arm 9 between two end positions. These two end positions may also be referred to as an upper end position and a lower end position. In FIG. 5 the actuator arm 9 is illustrated at the upper end position. In FIG. 4, the actuator arm 9 is illustrated as positioned at a midpoint between the two end positions, i.e. at a midpoint between the upper end position and the lower end position.

As indicated in FIG. 4, according to the illustrated embodiments, the cutting assembly 1 is configured such that the sliding directions d3, d4 of the actuator arm 9 in the aperture 7 is parallel to a plane PL2 comprising a first pivot axis p1 of a link arm a1 at the cutting arrangement 4 and a second pivot axis p2 of the link arm a1 at the mounting unit 8 when the actuator arm 9 is positioned at a midpoint between the two end positions. This may also be expressed as that each link arm a1-a4 of the link arm arrangement 5 is parallel to the sliding directions d3, d4 of the actuator arm 9 in the aperture 7 when the actuator arm 9 is positioned at the midpoint between the two end positions.

However, according to further embodiments, the cutting assembly 1 may be configured such that an angle a0 between a sliding direction d3, d4 of the actuator arm 9 in the aperture 7 and a plane PL2 comprising a first pivot axis p1 of a link arm a1 at the cutting arrangement 4 and a second pivot axis p2 of the link arm a1 at the mounting unit 8 is less than 15 degrees, or is less than 5 degrees, when the actuator arm 9 is positioned at the midpoint between the two end positions. Accordingly, in such embodiments, each link arm a1-a4 of the link arm arrangement 5 may be substantially parallel to the sliding directions d3, d4 of the actuator arm 9 in the aperture 7 when the actuator arm 9 is positioned at a midpoint between the two end positions.

According to the illustrated embodiments, the linear actuator 10 comprises a screw 11 rotatably arranged relative to the mounting unit 8 around a rotation axis Ra. The rotation axis Ra of the screw 11 is parallel to the directions d1, d2 in which the linear actuator 10 is configured to move the actuator arm 9. In other words, according to the illustrated embodiments, the rotation axis Ra of the screw 11 is perpendicular to the first plane PL1 when the cutting assembly 1 is mounted to the robotic lawnmower 2.

The linear actuator 10 further comprises a motor 13 controllable to rotate the screw 11 around the rotation axis Ra. According to the illustrated embodiments, the motor 13 is an electric motor configured to be powered using electricity from the one or more batteries of the robotic lawnmower 2. The motor 13 of the linear actuator 10 may also be referred to as an actuator motor.

According to the illustrated embodiments, the motor 13 of the linear actuator 10 is connected to the screw 11 via a set of gears 13′, 11′, wherein one gear 13′ is attached to an output shaft of the motor 13 and one gear 11′ is attached to the screw 11. In FIG. 4 and FIG. 5, a rotation axis Rm of the output shaft of the motor 13 is indicated. According to the illustrated embodiments, the rotation axis Rm of the output shaft of the motor 13 is parallel to the rotation axis Ra of the screw 11. Moreover, according to the illustrated embodiments, the gear 13′ being attached to the output shaft of the motor 13 is smaller than the gear 11′ attached to the screw 11 to form a reduction transmission ratio between the motor 13 and the screw 11. According to further embodiments, the linear actuator 10 may comprise another type of transmission between the motor 13 and the screw 11 or a direct connection between the output shaft of the motor 13 and the screw 11.

The linear actuator 10 further comprises a follower portion 9′. The follower portion 9′ is fix relative to the actuator arm 9 and comprises threads 39 arranged in engaging contact with treads 31 of the screw 11. According to the illustrated embodiments, the follower portion 9′ is part of the actuator arm 9. According to further embodiments, the follower portion 9′ may be a separate part being attached to the actuator arm 9.

According to the illustrated embodiments, the linear actuator 10 is arranged at least partially between the link arms a1-a4 of the link arm arrangement 5. That is, in more detail, the screw 11 of the linear actuator 10 protrudes between the link arms a1-a4 of the link arm arrangement 5.

As mentioned, the cutting arrangement 4 comprises a motor mount unit 40, wherein the motor 20 is arranged inside the motor mount unit 40. According to the illustrated embodiments, the aperture 7 extends through the entire motor mount unit 40. According to further embodiments, the aperture 7 may extend through at least part of the motor mount unit 40. Moreover, the aperture 7 may extend through the motor mount unit 40 a distance greater than half the diameter of the motor mount unit 40 as measured in directions coinciding with sliding directions d3, d4 of the actuator arm 9 in the aperture 7. According to the illustrated embodiments, the cutting assembly 1 is configured such that the geometrical centre axis Ca of the motor mount unit 40 extends through the actuator arm 9.

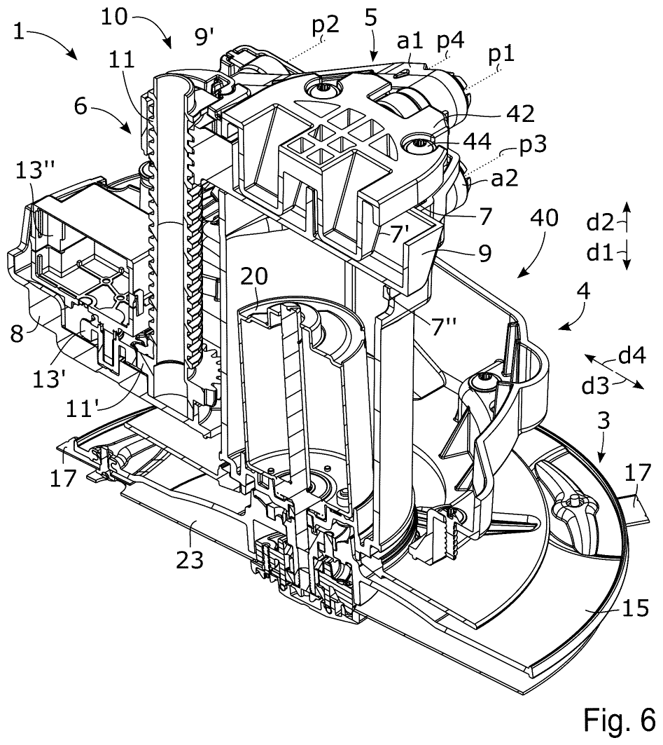

FIG. 6 illustrates a sectional view of the cutting assembly 1 depicted in FIG. 2-FIG. 5. In FIG. 6, the set of gears 13′, 11′ of the linear actuator 10 can be seen in a clear manner. Below, simultaneous reference is made to FIG. 1-FIG. 6, if not indicated otherwise.

As is best seen in FIG. 5, the motor mount unit 40 comprises a main body 40′ and a lid 42. The lid 42 is also indicated in FIG. 2 and FIG. 6. Moreover, as is indicated in FIG. 2 and FIG. 6, according to the illustrated embodiments, the lid 42 is removably attached to the main body 40′ using a number of fastening elements 44 in the form of screws. According to further embodiments, the lid 42 may be removably attached to the main body 40′ in another manner, such as by using another type of fastening elements, such as bolts, or by using a snap fit assembly, or the like.

As is indicated in FIG. 5 and FIG. 6, the aperture 7 is formed between surfaces 7′ of the lid 42 and surfaces 7″ of the main body 40′ of the motor mount unit 40.

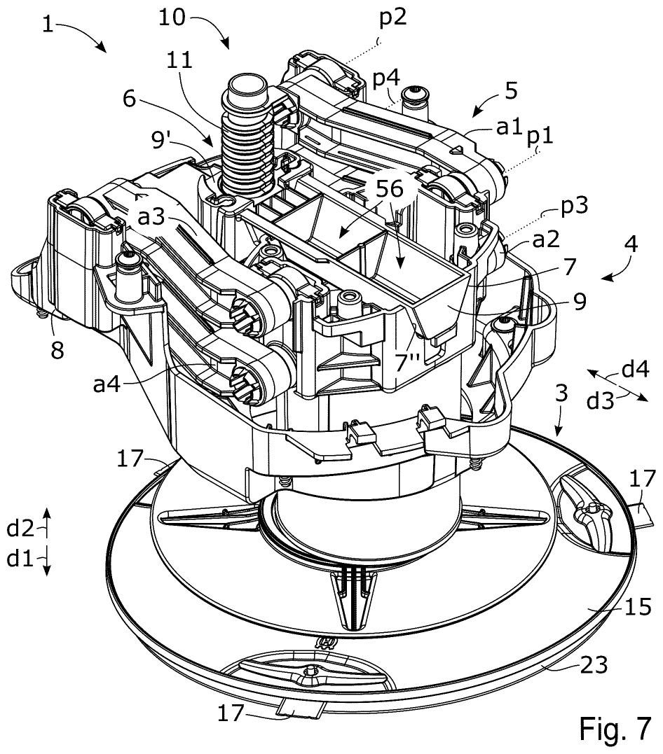

FIG. 7 illustrates the perspective view of the cutting assembly 1 illustrated in FIG. 2, in which the lid 42 has been removed. In FIG. 7, the engaging contact between the screw 11 of the linear actuator 10 and the follower portion 9′ of the actuator arm 9 can be seen in a clear manner. Moreover, the shape of the actuator arm 9 according to embodiments herein can be seen in a clear manner.

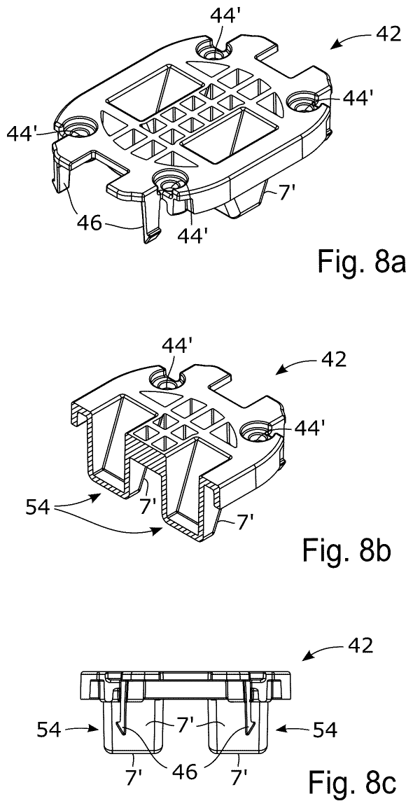

FIG. 8a illustrates a perspective view of the lid 42 of the motor mount unit 40 of the cutting assembly 1 according to the embodiments illustrated in FIG. 2-FIG. 7. As indicated in FIG. 8a, the lid 42 comprises a number of through holes 44′. Each of the number of through holes 44′ is configured to receive a fastening element 44 for attaching the lid 42 to the main body 40′ of the motor mount unit 40. All fastening elements 44 are indicated in FIG. 2.

Moreover, according to the illustrated embodiments, the lid 42 comprises a number of snap fit arms 46. Each of the number of snap fit arms 46 is configured to engage with a portion of the motor mount unit 40 for retaining the lid 42 relative to the main body 40′ of the motor mount unit 40 in a mounting procedure of the lid 42 to the main body 40′ of the motor mount unit 40.

FIG. 8b illustrates a sectional view of the lid 42 illustrated in FIG. 8a. As is indicated in FIG. 8b, the lid 42 comprises a pair of protrusions 54. Each of the pair of protrusions 54 is configured to protrude into a recess 56 of the actuator arm 9. The recesses 56 of the actuator arm 9 are illustrated in FIG. 7.

FIG. 8c illustrates a side view of the lid 42 illustrated in FIG. 8a. The pair of protrusions 54 and the snap fit arms 46 are also indicated in FIG. 8c. Below, simultaneous reference is made to FIG. 1-FIG. 8c, if not indicated otherwise.

According to the illustrated embodiments, outer surfaces 7′ of the protrusions 54 of the lid 42 form delimiting surfaces of the aperture 7. In other words, the aperture 7 is formed by a slot formed between surfaces 7′ of the lid 42 and surfaces 7″ of the main body 40′. Moreover, the slot is u-shaped. In more detail, the slot has a u-shaped cross section in a plane perpendicular to the directions d3, d4 in which the actuator arm 9 is slidably received in the aperture 7. In this manner, the structural integrity and robustness of the cutting assembly 1 can be further ensured.

Moreover, according to the illustrated embodiments, the actuator arm 9 is completely enclosed by the cutting arrangement 4, i.e., by the surfaces 7′ of the lid 42 and the surfaces 7″ of the main body 40′ of the motor mount unit 40 of the cutting arrangement 4. In this manner, a rigid cutting assembly 1 is provided and it can be ensured that no components of the cutting assembly 1 become unconnected during operation.

Moreover, due to the features of the cutting assembly 1 according to embodiments herein, conditions are provided for obtaining a large travel distance of the cutting arrangement 4 relative to the mounting unit 8, and thereby a large cutting height adjustment range, without impairing the structural rigidity of the cutting assembly 1.

This is because the number of link arms a1-a4 can take up and transfer forces between cutting unit 3 and the mounting unit 8 in an efficient manner. Furthermore, due to the number of link arms a1-a4 and the actuator arm 9 slidably received in the aperture 7 of the cutting arrangement 4, the cutting arrangement 4 has freedom to move relative to the mounting unit 8 in an overstress situation, such as a collision between the cutting unit 3 and an external item like a rock or root. This flexibility helps protect the linear actuator 10 and other components of the cutting assembly 1 from damage during such incidents.

Furthermore, due to the features of the cutting assembly 1, conditions are provided for a compact cutting assembly 1 facilitating ease of assembly in a factory, streamlining production processes, and reducing manufacturing costs, without compromising performance.

Moreover, since the cutting assembly 1 comprises the lid 42 being removably attached to the main body 40′ of the motor mount unit 40, a cutting assembly 1 is provided having conditions for being manufactured and assembled in a cost-efficient manner. Furthermore, a cutting assembly 1 is provided having conditions for facilitated service and repair.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A cutting assembly configured to be mounted to a robotic lawnmower to cut vegetation, the cutting assembly comprising:
a mounting unit configured to be mounted to a lawnmower body of the robotic lawnmower,
a cutting arrangement comprising a cutting unit,
a link arm arrangement connecting the cutting arrangement to the mounting unit, and
a cutting height adjustment mechanism,
wherein the link arm arrangement comprises a number of link arms each pivotally attached to the mounting unit and to the cutting arrangement around pivot axes,
and wherein the cutting height adjustment mechanism comprises an actuator arm slidably received in an aperture of the cutting arrangement and a linear actuator configured to move the actuator arm relative to the mounting unit.

2. The cutting assembly according to claim 1, wherein the linear actuator is configured to move the actuator arm in directions perpendicular to each of the pivot axes.

3. The cutting assembly according to claim 1, wherein the linear actuator is configured to move the actuator arm in directions being perpendicular to directions in which the actuator arm is slidably received in the aperture.

4. The cutting assembly according to claim 1, wherein the linear actuator is arranged at least partially between the link arms of the link arm arrangement.

5. The cutting assembly according to claim 1, wherein the linear actuator comprises a screw rotatably arranged relative to the mounting unit around a rotation axis, a motor controllable to rotate the screw around the rotation axis, and a follower portion, and wherein the follower portion is fix relative to the actuator arm and comprises threads arranged in engaging contact with treads of the screw.

6. The cutting assembly according to claim 1, wherein the cutting unit comprises a cutting disc and a number of cutting members each pivotally arranged at a periphery of the cutting disc.

7. The cutting assembly according to claim 1, wherein the cutting arrangement comprises a motor configured to rotate the cutting unit.

8. The cutting assembly according to claim 7, wherein the motor is an electric motor.

9. The cutting assembly according to claim 7, wherein the cutting arrangement comprises a motor mount unit, wherein the motor is arranged inside the motor mount unit, and wherein the aperture extends through at least part of the motor mount unit.

10. The cutting assembly according to claim 9, wherein the aperture extends through the motor mount unit a distance greater than half the diameter of the motor mount unit as measured in directions coinciding with sliding directions of the actuator arm in the aperture.

11. The cutting assembly according to claim 9, wherein the aperture extends through an entirety of the motor mount unit.

12. The cutting assembly according to claim 9, wherein a geometrical centre axis of the motor mount unit extends through the actuator arm.

13. The cutting assembly according to claim 9, wherein the motor mount unit comprises a main body and a lid, wherein the lid is removably attached to the main body, and wherein the aperture is formed between surfaces of the lid and surfaces of the main body.

14. The cutting assembly according to claim 13, wherein the lid is removably attached to the main body using a number of fastening elements.

15. The cutting assembly according to claim 1, wherein the aperture is formed by a slot.

16. The cutting assembly according to claim 15, wherein the slot is u-shaped.

17. The cutting assembly according to claim 1, wherein the link arm arrangement comprises four link arms.

18. The cutting assembly according to claim 1, wherein the link arms of the link arm arrangement are of equal length.

19. The cutting assembly according to claim 1, wherein the linear actuator is controllable to move the actuator arm between two end positions, and wherein the link arm arrangement is configured such that an angle between a sliding direction of the actuator arm in the aperture and a plane comprising a first pivot axis of a link arm at the cutting arrangement and a second pivot axis of the link arm at the mounting unit is less than 15 degrees, when the actuator arm is positioned at a midpoint between the two end positions.

20. A robotic lawnmower comprising the cutting assembly according to claim 1.
